(19) United States
(12) Patent Application Publication
(10) Pub. No.: US 2015/0246371 A1
(43) Pub. Date: Sep. 3, 2015

(54) METHOD OF COLD SPRAYING COMPONENTS OF A GAS TURBINE ENGINE MASK THEREFOR

(71) Applicant: Pratt & Whitney Canada Corp., Longueuil (CA)

(72) Inventor: Pierre VERRIER, Sainte-Julie (CA)

(73) Assignee: Pratt & Whitney Canada Corp., Longueuil (CA)

(21) Appl. No.: 14/193,414

(22) Filed: Feb. 28, 2014

(51) Int. Cl. B05C 21/00; C23C 4/08; C23C 4/12; C23C 4/00

(52) U.S. Cl. CPC B05C 21/005; C23C 4/005; C23C 4/08; C23C 4/121

(57) ABSTRACT

A method of cold spray coating a target surface of a component, the coating provided using selected solid powders, the method comprising: placing a mask onto the component to cover an area of the component adjacent the target surface which is not to be coated, the mask having a masking top surface provided of a material selected to be non-adhesive with the selected solid powders when cold-sprayed onto the masking top surface, the mask having a melting point above a temperature at which cold spray is performed; cold spraying the target surface with the selected solid powders, including at least some overspraying onto the mask; removing the overspray from the mask; and removing the mask from the component. A mask for a cold sprayed component of a gas turbine engine is also presented.

### TECHNICAL FIELD

The application relates generally to methods of cold spray, and more particularly to methods of cold spraying components of a gas turbine engine.

### BACKGROUND OF THE ART

When spray coating a surface, coating is sometimes desired only on specific portions of that surface. In such cases, the operator can direct the spray so as to avoid accidentally spraying adjacent portions. However, this may result in imprecise coating and most likely in coating of those portions of the surface that should have been devoid of coating. The operator can use a masking tape, but the tape may detach from the surface due to the pressure exerted by the spray. In some cases, the temperatures involved may cause tape to even melt and bond to the surface it was masking. To remove the excess coating, the operator may have to machine the portions of the surface that have been involuntarily coated, which is time consuming and may deteriorate the masking pattern.

### SUMMARY

In one aspect is provided a method of cold spray coating a target surface of a component, the coating provided using selected solid powders, the method comprising: placing a mask onto the component to cover an area of the component adjacent the target surface which is not to be coated, the mask having a masking top surface provided of a material selected to be non-adhesive with the selected solid powders when cold-sprayed onto the masking top surface, the mask having a melting point above a temperature at which cold spray is performed; cold spraying the target surface with the selected solid powders, including at least some overspraying onto the mask; removing the overspray from the mask; and removing the mask from the component.

In another aspect, there is provided a mask for a cold sprayed component of a gas turbine engine, the mask comprising: a body delimited by a top surface, a bottom surface, and a periphery, the bottom surface adapted to contact and mask a portion of the component to be devoid of coating, the bottom surface having a characteristic of being non-adhesive with the surface of the component, the top surface adapted to be exposed to solid powders of the cold spray when the body masks the component, the top surface having a characteristic of being non-adhesive with the solid powders when cold sprayed at applicable temperatures and pressures, and the periphery shaped to define a masking pattern on the component, the body having a melting point above a temperature at which cold spray is performed, whereby the mask ensures a reproduction of said masking pattern throughout uses of the mask in cold spraying similar one of said component.

### DESCRIPTION OF THE DRAWINGS

Reference is now made to the accompanying figures in which:

FIG. 1 is a schematic cross-sectional view of a gas turbine engine;

FIG. 2 is a schematic of a substrate, for use in a gas turbine engine such as the gas turbine engine of FIG. 1, being cold sprayed and having a mask thereon; and

FIG. 3 is a flow chart of a method of cold spraying a substrate such as the one of FIG. 2.

### DETAILED DESCRIPTION

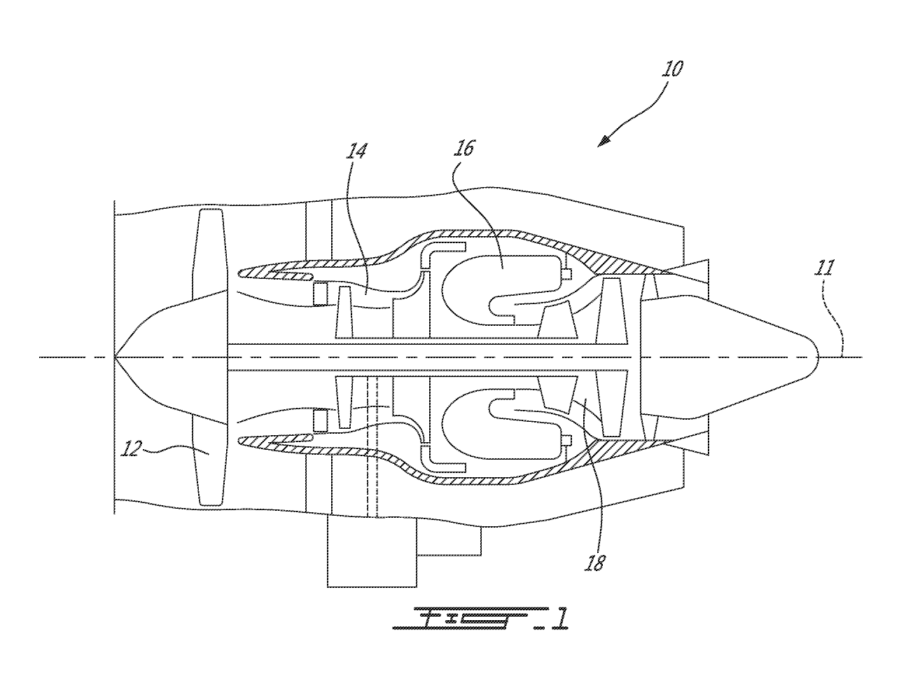

FIG. 1 illustrates a gas turbine engine 10 of a type preferably provided for use in subsonic flight, generally comprising in serial flow communication a fan 12 through which ambient air is propelled, a compressor section 14 for pressurizing the air, a combustor 16 in which the compressed air is mixed with fuel and ignited for generating an annular stream of hot combustion gases, and a turbine section 18 for extracting energy from the combustion gases. Some parts of the engine 10 have spray-coated surfaces. As such, a gas turbine engine component provides an example application of the methods described below.

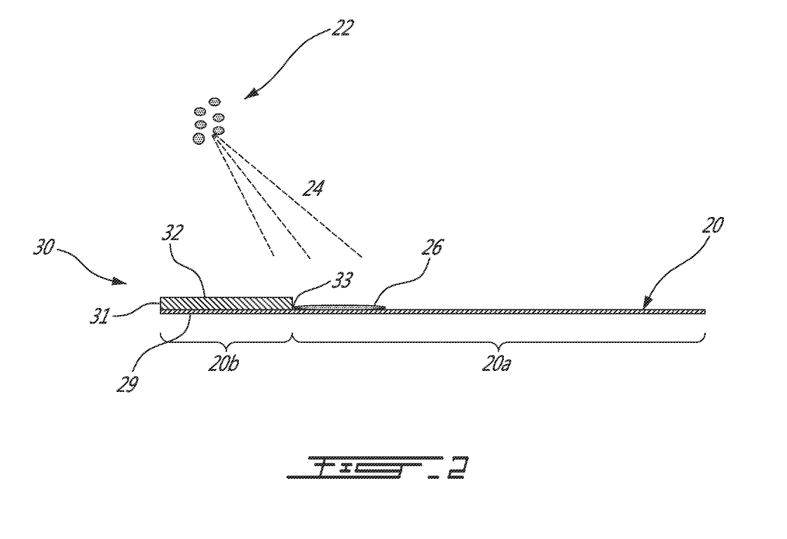

Referring to FIG. 2, a component or substrate 20, for example as may be for use in an engine such as the gas turbine engine 10, is to be cold sprayed with a desired coating. Cold spray is a coating deposition method where solid powders 22 are projected in gas jets 24. In opposition to thermal spray, the solid powders 22 in the cold spray process are not melted. A suitable cold spray gun (not shown) may be used to propel the solid powders 22 into jets 24. Upon impacting with the substrate 20, the solid powders 22 undergo plastic deformation which allows them to adhere to the substrate 20 and as a result create a coating 26. Metals, polymers, and composites are examples of materials which can be deposited using cold spray. In one embodiment, the cold spray uses nitrogen at 350° C., 35 bars and a standoff between 20 mm and 40 mm from the substrate 20. In one embodiment, the standoff is at a distance is at 30 mm.

The substrate 20 has a portion 20a onto which coating is desired to be applied and a portion 20b, adjacent to the portion 20a, onto which coating is undesired. In order to prevent the portion 20b from being accidently coated by the solid powders 22, a mask 30 covers the portion 20b. The mask 30 has a body 31 which periphery determines a masking pattern 33, i.e. a delimitation of a coating between a zone covered by coating and a zone free of coating.

The mask 30 may have a bottom surface 29 congruent with the portion 20b so as to fit snuggly over the portion 20b, at least at the periphery so as to prevent bleed of the coating. The mask 30 may be placed onto the portion 20b and retained there, in one example, by its tight fit with the portion 20b. In another example, the mask 30 may be temporarily retained on the portion 20b by a suitable securing means, such as clips. The amount and type of securing will be a matter of choice depending on the selected cold spray process; indeed, the cold spraying is often automated and may involve quick movements of the substrate 20 relative to a cold spray source, in which case are more robust securing approach will be needed. The mask 30 may be provided as a rigid or flexible body 31. The mask 30 is typically made of a material substantially resistant to the temperatures and pressures generated during the cold spray process, so that the mask 30 does not appreciably deform and/or bond to or alter the underlying portion 20b of the substrate 20.

The mask 30 has a top surface 32 made of a material that is preferably non-adhesive with the solid powders 22 which may be over-sprayed onto the mask 30. The mask 30 is also non-adhesive with top portion 20a of the substrate 20. The top surface 32 is the surface that will be in contact with the solid powders 22 projected by the cold spray. By non-adhesive, one should understand a surface which does not form a metallurgical or a mechanical bond with the solid powders projected thereon, or with the top portion 20a of the substrate 20 is spite of the pressure of the solid powders projected thereon. Any bond that is, for one example, easily breakable by wiping or dusting the surface for example would not be considered as an adhesive bond. Another example of a non-adhesive bond is a static bond. Because the material of the top surface 32 is non-adhesive, the sprayed metal powders 22 can be removed from the top surface 32 of the mask 30 without significant effort. This may allow the mask 30 to be reused single or multiple times in some situations. In addition. the material of the mask 30 is chosen to have a melting point above a temperature at which cold spray is performed. By choosing a mask 30 which does not plastically deform, the masking pattern 33 is kept intact over the one or more uses of the mask 30. It one example, the body 31, top and/or bottom surfaces 32, 29 may be made of a same non-adhesive, non-deforming/melting material. The bottom and top surfaces 29, 32 may have the same non-adhesive material, or may be different. Some materials may be adhesive for some selected solid powders, but may be non-adhesive for other selected solid powders. In one example, the solid powders 22 are Al-12%Si, the selected material/coating for the mask 30 (including top surface 32 and bottom surface 29) is one of Nylatron® NSM and Nylatron® MC901 (i.e. solid lubricant filled type 6), the substrate is one of magnesium and aluminum, and the cold spray process is as described above. In this example, the material/coating for the mask 30 (or at least for top surface 32) is chosen so that the desired coating of Al-12%Si does not adhere with the mask 30. Other materials for the mask 30 are contemplated. In a non-limiting example, the mask 30 may be made of a nylon or a cast nylon. Other factors for the selection of the top surface 32 material include resistance properties in regards to gas high temperatures and high pressure combinations used in the cold spray process. In the example above, the mask 30 made of one of Nylatron® NSM and Nylatron® MC901 is resistant to the pressures and temperatures of the cold spray process associated with Al-12%Si metal powders 22. It is pointed out that the expressions “bottom surface 29” and “top surface 32” are used not in relation the gravity, but rather as indicating that the top is exposed to cold spray and typically faces away from the substrate 20, while the bottom surface 29 of the mask 30 is that facing toward the substrate 20 and in contact with the portion 20b of the substrate 20.

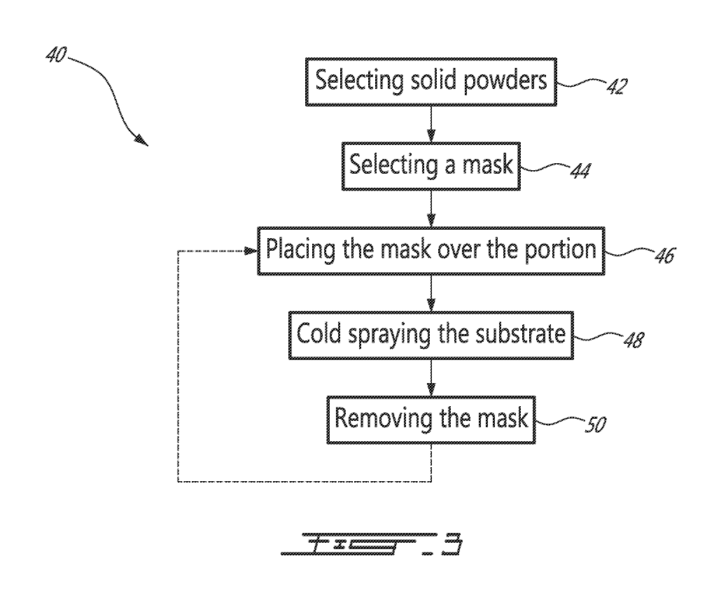

Turning now to FIG. 3, a method 40 of cold spraying the substrate 20 will now be described.

The method 40 starts at step 42 by selecting the solid powders 22 corresponding to the desired coating 26 on the substrate 20. In one example, the desired coating 26 is Al-12%Si and solid powders 22 of Al-12%Si are selected and the substrate 20 is made of one of magnesium and aluminium.

From step 42, the method 40 goes to step 44 where the mask 30 and the portion 20b of the substrate 20 to be devoid of the coating 26 are selected. The mask 30 may be selected before or after selecting the portion 20b. The mask 30 is selected to have a shape allowing the cover of the portion 20b. The mask 30 is also selected to have its top surface 32 non-adhesive with the selected solid powders 22, and to have a melting point above a temperature at which cold spray is performed. As such, the mask 30 is selected to not deform and alter the masking pattern 33, and to not bond with the portion 20b during the cold spray, both which could negatively alter the quality of the masking operation. In one embodiment where the solid powders 22 are Al-12%Si and the cold spray temperatures for cold spraying Al-12%Si are below 660° C. (temperature at which the mask 30 may be altered), the mask 30 may have its top surface 32 made of one of Nyaltron® NSM and Nylatron® MC901. In one embodiment, the cold spray process involves pressures between 20 and 50 bars and temperatures around 350° C. The above ranges of temperatures and pressures correspond to standard cold spray processes for the particular selected solid powders 22, though other selected process may require a mask which performs to different criteria.

From step 44, the method 40 goes to step 46 where the mask 30 is placed onto the portion 20b. As mentioned above, the mask 30 may or may not be secured by additional securing means to the portion 20b, according to the process requirements.

From step 46, the method 40 goes to step 48 where the substrate 20 is cold sprayed with the solid powders 22. In one embodiment, the cold spray uses nitrogen at 350° C. and 35 bars as a gas, and a standoff between 20 mm and 40 mm.

From step 48, the method 40 goes to step 50 where the mask 30 is removed (as is described further below) from the portion 20b which leads to obtaining the coating 26 and the masking pattern 33 onto the substrate 20. The mask 30 indestructively removed from the substrate 20 as a unitary piece after cold-spraying is complete. The masking pattern 33 delimits the desired coating 26 disposed on the portion 20a of the substrate 20 adjacent to the portion 20b and the absence of coating 26 on the portion 20a. Overspray may be removed from the mask before or after removing mask from the portion 20b.

Because the mask 30 is non-adhesively mounted onto the portion 20b and has a material selected to not melt and bond with the portion 20b, removing the mask 30 may, in one example, involves picking up (e.g. lifting, peeling back, or other suitable approach) the mask 30 from the substrate 20. If the mask 30 was temporarily secured to the portion 20b, the step 50 includes removing the securing from the mask 30 and/or from the portion 20b before picking up or otherwise removing the mask 30 from the substrate 20. Because the mask 30 is non-adhesive with the solid powders 22, the mask 30 may be optionally wiped or dusted to remove any excess coating that may have been applied to the mask there. The mask 30 would preferably not altered by the wiping, leaving the mask to be removed by other suitable means, potentially for reuse if appropriate.

The mask 30 may, in one example, be provided such that it may be non-destructively removed from the component and reused for masking another component in a subsequent cold spray process. The subsequent component preferably is similar (if not identical) to the substrate 20 and having the same configuration, i.e. portion 20b to be covered with the mask 30 directly to reproduce the masking pattern 33. In another example, a mask 30 which not have the non-adhesive surface 32, the mask 30 would need to be machined or abraded from the component, which would alter the mask 30, may modify its shape and in turn change the masking pattern, but otherwise leave the masking material in a condition suitable for reuse. Thus, the removed mask material 30 may be suitable for collection, processing and reapplication as a masking material and thus subsequent use despite the mask 30 form being destroyed during removal. In another example, a non-adhesive coating may nevertheless be destructive removed because a complex component shape requires such removal, or process efficiency is not gained by non-destructive removal, or other process detail gravitating towards destructive removal of the mask 30. The present approach thus provides the skilled person with options is designing an optimal process. In any event, a dotted arrow illustrates in FIG. 3 the possible reusability of the mask 30. After removing the mask 30 and obtaining the masking pattern 33, the reusable mask 30 is placed, using a suitable process, onto another substrate at a portion of to be devoid of coating identical to the portion 20b. This substrate is then cold sprayed with the solid powders 22. The mask 30 is then removed thereby obtaining the desired coating and a masking pattern identical to that of the substrate 20 on the other substrate. The process steps are thus repeated as necessary for subsequent components 20 to be masked and cold-spray coated.

Using a mask allows covering portions of a substrate and avoiding overspray on areas where coating is not desired. A mask having a bottom surface congruent with the substrate allows for precision masking. In addition, the use of a non-adhesive material for the top surface may allow the mask to be substantially free of coating, while using a non-adhesive material for the mask bottom surface may impede adherence of the mask to the component, which may facilitate removal of the mask from the component. As a consequence, the mask may possible be used multiple times to reproduce similar masking patterns within desired tolerances Traditional masks may tend to have their shape altered by the elimination of the previous coating or the accumulation of coating and as a consequence won't allow a reproducible masking pattern. If the coating is not eliminated from one cold spray process to another, bridging from such traditional masks onto the substrate may occur. This could shadow the area to be sprayed or cause bonding problems when the mask is removed. Providing a non-adhesive surface on the mask may help address these or other problems. Providing a mask which is non-deformable and non-destructibly removable from the component surface may allow the mask to be reused multiple times without any alteration. These and other features of the present approach may help ensure masking pattern reproducibility which may improve coating preciseness and/or may save costs and time in the masking-coating-demasking process.

The above description is meant to be exemplary only, and one skilled in the art will recognize that changes may be made to the embodiments described without departing from the scope of the invention disclosed. For example, any suitable mask material having the properties described with respect to the substrate material and/or cold-spray material may be used. Any suitable method of applying and/or removing the mask may be used. Any suitable cold-spray process, materials and parameters may be used. Still other modifications which fall within the scope of the present invention will be apparent to those skilled in the art, in light of a review of this disclosure, and such modifications are intended to fall within the appended claims.

1. A method of cold spray coating a target surface of a component, the coating provided using selected solid powders, the method comprising:
placing a mask onto the component to cover an area of the component adjacent the target surface which is not to be coated, the mask having a masking top surface provided of a material selected to be non-adhesive with the selected solid powders when cold-sprayed onto the masking top surface, the mask having a melting point above a temperature at which cold spray is performed;
cold spraying the target surface with the selected solid powders, including at least some overspraying onto the mask;
removing the overspray from the mask; and
removing the mask from the component.

2. The method as defined in claim 1, further comprising the steps of removing the mask after cold-spraying is complete and then reusing the mask to cold spray a second component identical to said component.

3. The method as defined in claim 1, wherein the mask has a component-facing surface which is non-adhesive to the component and wherein the mask is non-destructively removed from the component as a unitary piece after cold-spraying is complete.

4. The method as defined in claim 1, wherein the top surface is made of a nylon, and wherein the selected solid powders contain aluminum.

5. The method as defined in claim 1, wherein the entire mask is made of a nylon, and wherein the selected solid powders contain aluminum.

6. The method as defined in claim 1, wherein the top surface is made of a cast nylon.

7. The method as defined in claim 1, wherein the selected solid powders are Al-12%Si.

8. The method as defined in claim 1, wherein cold spraying comprises cold spraying a gas at a pressure comprises between 20 and 50 bars and at a temperature below 660° C.

9. The method as defined in claim 1, wherein cold spraying comprises cold spraying nitrogen at 350° C. and 35 bars at a standoff between 20 mm and 40 mm.

10. The method as defined in claim 1, wherein:
the step of placing the mask includes providing additional securing to secure the placed mask to the component after being applied to the component; and
the step of removing the mask includes removing said additional securing from one of the mask and the component.

11. The method as defined in claim 1, where the step of removing the overspray includes dusting the mask to remove oversprayed coating.

12. A mask for a cold sprayed component of a gas turbine engine, the mask comprising:
a body delimited by a top surface, a bottom surface, and a periphery, the bottom surface adapted to contact and mask a portion of the component to be devoid of coating, the bottom surface having a characteristic of being non-adhesive with the surface of the component, the top surface adapted to be exposed to solid powders of the cold spray when the body masks the component, the top surface having a characteristic of being non-adhesive with the solid powders when cold sprayed at applicable temperatures and pressures, and the periphery shaped to define a masking pattern on the component, the body having a melting point above a temperature at which cold spray is performed, whereby the mask ensures a reproduction of said masking pattern throughout uses of the mask in cold spraying similar one of said component.

13. The mask as defined in claim 11, wherein the bottom surface of the mask has a shape adapted to be congruent with the portion of the component of the gas turbine engine to be devoid of cold spray coating.

14. The mask as defined in claim 11, wherein the top surface is made of a nylon.

15. The mask as defined in claim 11, wherein the top surface is made of a cast nylon.
